(19) United States
(12) Patent Application Publication
(10) Pub. No.: US 2017/0320217 A1
(43) Pub. Date: Nov. 9, 2017

(54) LINEAR EXTENSION AND RETRACTION MECHANISM, AND ROBOT ARM MECHANISM

(71) Applicant: LIFE ROBOTICS INC., Tokyo (JP)

(72) Inventors: Woo-Keun YOON, Tokyo (JP); Shinji KURIHARA, Tokyo (JP); Hikaru SANO, Tokyo (JP)

(21) Appl. No.: 15/657,838

(22) Filed: Jul. 24, 2017

Related U.S. Application Data
(63) Continuation of application No. PCT/JP2016/051627, filed on Jan. 20, 2016.

(30) Foreign Application Priority Data
Jan. 24, 2015 (JP) 2015-011868

(51) Int. Cl. B25J 17/00; B25J 18/02

(52) U.S. Cl. CPC B25J 17/00; B25J 18/02

(57) ABSTRACT

Rigidity of an arm is improved in a linear extension and retraction mechanism. The linear extension and retraction mechanism includes a first connection piece string consisted of a plurality of first connection pieces; a second connection piece string consisted of a plurality of second connection pieces; and an ejection section adapted to form a columnar body by joining the first connection piece string to the second connection piece string and support the columnar body, in which a foremost one of the plurality of second connection pieces is connected with a foremost one of the plurality of first connection pieces, the first and second connection piece strings are joined with each other to constrain bending, thereby a columnar body with a tubular shape being formed, and the columnar body is relaxed when the first and second connection piece strings are separated from each other. In the linear extension and retraction mechanism, the first connection pieces have a width substantially equivalent to spacing between side plates of the second connection pieces and are fitted into the second connection pieces.

### CROSS-REFERENCE TO RELATED APPLICATIONS

This application is continuation application of International Patent Application No. PCT/JP2016/051627 filed on Jan. 20, 2016, which is based upon and claims the benefit of priority from the prior Japanese Patent Application No. 2015-011868, filed Jan. 24, 2015, the entire contents of which are incorporated herein by reference.

### FIELD

Embodiments described herein relate generally to linear extension and retraction mechanism, and robot arm mechanism

### BACKGROUND

Conventionally, articulated robot arm mechanisms are used in an industrial robot and various other fields. Some of such articulated robot arm mechanisms are equipped with a linear extension and retraction mechanism, for example. The linear extension and retraction mechanism includes a plurality of connection pieces coupled together, for example, bendably in a row. When an arm is extended, the plurality of connection pieces thus far housed in a support body is sent out as a columnar body having a certain degree of rigidity with bending of the connection pieces being constrained. On the other hand, when the arm is retracted, the columnar body is pulled back to be stored, becoming bendable with the constraints on the bending being relaxed in the support body.

### BRIEF SUMMARY OF INVENTION

Rigidity of an arm is improved in a linear extension and retraction mechanism.

A linear extension and retraction mechanism according to an embodiment of the present invention includes: a first connection piece string, the first connection piece string including a plurality of first connection pieces coupled together bendably, the plurality of first connection pieces being shaped like a flat plate; a second connection piece string, the second connection piece string including a plurality of second connection pieces coupled together bendably, the plurality of second connection pieces being provided with a U-shaped cross section, a foremost one of the plurality of second connection pieces being connected with a foremost one of the plurality of first connection pieces, the first and second connection piece strings being joined with each other to constrain bending, thereby a columnar body having a tubular shape being formed, the columnar body being relaxed when the first and second connection piece strings are separated from each other; and an ejection section adapted to form the columnar body by joining the first connection piece string to the second connection piece string and support the columnar body, wherein the first connection pieces have a width substantially equivalent to spacing between side plates of the second connection pieces and are fitted into the second connection pieces.

### BRIEF DESCRIPTION OF THE VIEWS OF THE DRAWING

FIG. 1 is an external perspective view of a robot arm mechanism according to an embodiment of the present invention;

FIG. 2 is a diagram showing the robot arm mechanism of FIG. 1 using graphic symbol representation;

FIG. 3 is a side view of the internal components of the robot arm mechanism of FIG. 1;

FIG. 4 is a side view showing a structure of a first connection piece of the robot arm mechanism according to the present embodiment;

FIG. 5 is a perspective view showing a rear structure of the first connection piece shown in FIG. 4;

FIG. 6 is a perspective view showing a front structure of the first connection piece shown in FIG. 4;

FIG. 7 is a side view showing a structure of a second connection piece of the robot arm mechanism according to the present embodiment;

FIG. 8 is a sectional view of the second connection piece 24 taken along line A-A′ in FIG. 7;

FIG. 9 is a perspective view showing a rear structure of the second connection piece shown in FIG. 7;

FIG. 10 is a perspective view showing a front structure of the second connection piece shown in FIG. 7;

FIG. 11 is a perspective view showing a structure of an arm section of the robot arm mechanism according to the present embodiment;

FIGS. 12A and 12B are sectional views showing a characteristic part of the arm section shown in FIG. 11;

FIG. 13 is a perspective view showing a structure of an arm section of a robot arm mechanism according to a first variation;

FIGS. 14A and 14B are sectional views showing a characteristic part of the arm section of FIG. 13;

FIG. 15 is a perspective view showing a structure of an arm section of a robot arm mechanism according to a second variation;

FIGS. 16A and 16B are sectional views showing a characteristic part of the arm section of FIG. 15;

FIGS. 17A and 17B are sectional views showing a characteristic structure of an arm section of a robot arm mechanism according to a third variation; and

FIGS. 18A and 18B are sectional views showing a characteristic structure of an arm section of a robot arm mechanism according to a fourth variation.

### DETAILED DESCRIPTION

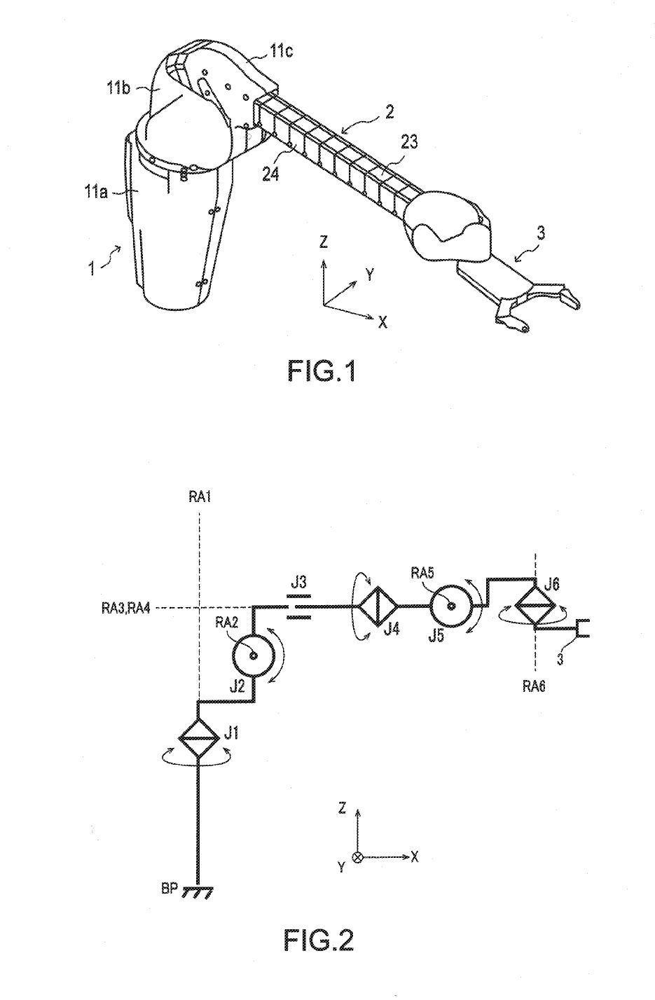

FIG. 1 is an external perspective view of a robot arm mechanism according to the present embodiment. FIG. 2 is a diagram showing the robot arm mechanism of FIG. 1 using graphic symbol representation. The robot arm mechanism includes a base 1 substantially cylindrical in shape and an arm section 2 connected to the base 1. An end effector 3 is attached to a tip of the arm section 2. A hand section capable of gripping an object is illustrated in FIG. 1 as the end effector 3. The end effector 3 is not limited to the hand section and may be another tool, a camera, or a display. An adaptor may be attached to the tip of the arm section 2 to allow the end effector 3 to be replaced with any type of end effector 3.

The arm section 2 has a plurality of—six herein—joints J1, J2, J3, J4, J5, and J6. The plurality of joints J1, J2, J3, J4, J5, and J6 are arranged in order from the base 1. Generally, first, second, and third joints J1, J2, and J3 are called root three axes, and fourth, fifth, and sixth joints J4, J5, and J6 are called wrist three axes and adapted to change a posture of a hand section 3. At least one of the joints J1, J2, and J3 constituting the root three axes is a linear motion joint. Here, the third joint J3 is a linear motion joint and is configured to be a joint with a relatively long extension distance, in particular.

The first joint J1 is a torsion joint that turns on the first axis of rotation RA1 supported, for example, perpendicularly to a base plane. The second joint J2 is a bending joint (revolute joint) that turns on the second axis of rotation RA2 perpendicular to the first axis of rotation RA1. The third joint J3 extends and retracts linearly along the third axis (axis of linear movement) RA3 perpendicular to the second axis of rotation RA2. The fourth joint J4 is a torsion joint (revolute joint) that turns on the fourth axis of rotation RA4 which matches the third axis of movement RA3. The fifth joint J5 is a bending joint that turns on the fifth axis of rotation RA5 orthogonal to the fourth axis of rotation RA4. The sixth joint J6 is a bending joint that turns on the sixth axis of rotation RA6 orthogonal to the fourth axis of rotation RA4 and perpendicular to the fifth axis of rotation RA5.

The arm support body (first support body) 11a forming the base 1 has a cylindrical hollow structure formed around the axis of rotation RA1 of the first joint J1. The first joint J1 is mounted on a fixed base (not shown). When the first joint J1 rotates, the first support body 11a axially rotates along with the turn of the arm section 2. Note that the first support body 11a may be fixed on a ground plane. In this case, the arm section 2 turns independently of the first support body 11a. The second support body 11b is connected to the upper part of the first support body 11a.

The second support body 11b has a hollow structure continuous with the first support body 11a. One end of the second support body 11b is attached to a rotating section of the first joint J1. The other end of the second support body 11b is open, and a third support body 11c is fitted therein pivotally on the axis of rotation RA2 of the second joint J2. The third support body 11c has a scaly hollow structure communicating with the first support body 11a and the second support body 11b. Along with bending rotation of the second joint J2, a rear part of the third support body 11c is housed in and sent out from the second support body 11b. The rear part of the third joint J3, which constitutes a linear motion joint of the arm section 2, is housed inside the continuous hollow structure of the first support body 11a and the second support body 11b by retraction thereof.

The arm support body (first support body) 11a forming the base 1 has a cylindrical hollow structure formed around the axis of rotation RA1 of the first joint J1. The first joint J1 is mounted on a fixed base (not shown). When the first joint J1 rotates, the first support body 11a axially rotates along with the turn of the arm section 2. Note that the first support body 11a may be fixed on a ground plane. In this case, the arm section 2 turns independently of the first support body 11a. The second support body 11b is connected to the upper part of the first support body 11a.

A lower part of a rear end of the third support body 11c is fitted in a lower part of an open end of the second support body 11b pivotally on the axis of rotation RA2. Consequently, the second joint J2 is configured as a bending joint that turns on the axis of rotation RA2. When the second joint J2 pivots, the arm section 2 pivots vertically, i.e., pivots up and down, on the axis of rotation RA2 of the second joint J2 together with the hand section 3.

The fourth joint J4 is a torsion joint having the axis of rotation RA4 which typically matches a center axis of the arm section 2 along an extension and retraction direction of the arm section 2, that is, the axis of movement RA3 of the third joint J3. When the fourth joint J4 rotates, the hand section 3 rotates on the axis of rotation RA4 from the fourth joint J4 to the tip thereof. The fifth joint J5 is a bending joint having the axis of rotation RA5 orthogonal to the axis of movement RA4 of the fourth joint J4. When the fifth joint rotates, the hand section 3 pivots up and down from the fifth joint J5 to its tip. The sixth joint J6 is a bending joint having an axis of rotation RA6 orthogonal to the axis of rotation RA4 of the fourth joint J4 and perpendicular to the axis of rotation RA5 of the fifth joint J5. When the sixth joint J6 rotates, the hand section 3 swings left and right.

As described above, the third joint J3 serving as a joint section makes up a main constituent of the arm section 2. The hand section 3 provided at the tip of the arm section 2 is moved to a given position by the first joint J1, the second joint J2 and the third joint J3, and placed in a given posture by the fourth joint J4, the fifth joint J5 and the sixth joint J6. In particular, a linear extension and retraction distance of the third joint J3 enables the hand section 3 to reach object in a wide range from a position close to the base 1 to a position far from the base 1. The third joint J3 is characterized by the linear extension and retraction distance realized by the linear extension and retraction mechanism constituting the third joint J3.

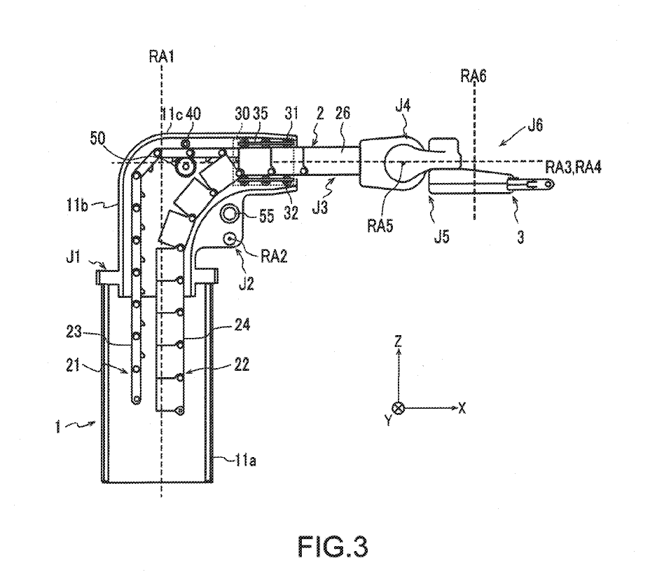

FIG. 3 is a side view of the robot arm mechanism of FIG. 1. As shown in FIG. 3, the linear extension and retraction mechanism includes a first connection piece string 21 and a second connection piece string 22. The first connection piece string 21 is consisted of a plurality of first connection pieces 23. Each pair of successive first connection pieces 23 are bendably coupled together at ends by a pin, forming a string. The first connection piece string 21 can freely bend inward and outward.

The second connection piece string 22 is consisted of a plurality of second connection pieces 24. Each pair of successive second connection pieces 24 are bendably coupled together at ends on bottom faces by a pin, forming a string. The second connection piece string 22 can bend inward. Each second connection piece 24 has a U-shaped cross section, and thus the second connection piece string 22 does not bend outward with side plates of adjacent second connection pieces 24 hitting each other. Note that a surface of the first connection piece 23 (second connection piece 24) which faces the second axis of rotation RA2 will be referred to as an inner surface and a surface on an opposite side will be referred to as an outer surface.

The leading first connection piece 23 of the first connection piece string 21 and the leading second connection piece 24 of the second connection piece string 22 are connected with each other by a head piece 26. For example, the head piece 26 has a combined shape of the second connection piece 24 and the first connection piece 23.

When the arm extends, the first and second connection piece strings 21 and 22 are sent outward through an opening in the third support body 11c with the head piece 26 serving as a leading piece. The first and second connection piece strings 21 and 22 are joined with each other in the ejection section 30 mounted near an opening in the third support body 11c. When the first and second connection piece strings 21 and 22 are kept joined, the first and second connection piece strings 21 and 22 constrain each other from bending. Consequently, the first and second connection piece strings 21 and 22 make up a columnar body having a certain degree of rigidity. The columnar body is a columnar rod body consisted of the first connection piece string 21 joined to the second connection piece string 22. The columnar body is generally formed into a tubular body having any of various cross sectional shape by a combination of the second connection piece 24 and the first connection piece 23. The tubular body is defined as a shape surrounded by a top plate, a bottom plate, and side plates on top, bottom, and left and right sides, respectively, with a front end portion and a rear end portion being left open.

When the arm retracts, the first and second connection piece strings 21 and 22 are pulled back to the opening in the third support body 11c. The first and second connection piece strings 21 and 22 making up the columnar body are separated from each other behind the ejection section 30. Each of the separated first and second connection piece strings 21 and 22 is returned to a bendable state, bent individually, and stored in the first support body 11a.

As shown in FIG. 3, the first connection piece string 21 and the second connection piece string 22 are joined with each other in the ejection section 30 mounted near an opening in the third support body 11c.

The ejection section 30 includes a plurality of upper rollers 31 and a plurality of lower rollers 32, which are supported by a frame 35 of a rectangular tubular shape. For example, the plurality of upper rollers 31 are arranged along a center axis of the arm at intervals substantially equivalent to the length of the first connection piece 23. Similarly, the plurality of lower rollers 32 are arranged along the center axis of the arm at intervals substantially equivalent to the length of the second connection piece 24. Behind the ejection section 30, a guide roller 40 and a drive gear 50 are provided, facing each other across the first connection piece string 21. The drive gear 50 is connected to a motor 55 via a speed reducer (not shown). On the inner surface of each first connection piece 23, a linear gear 239 is formed along a coupling direction. When the plurality of first connection pieces 23 are lined up linearly, the respective linear gears 239 are connected linearly, making up a long linear gear. The drive gear 50 is meshed with the unified linear gear. The linearly connected linear gears 239 make up a rack-and-pinion mechanism in conjunction with the drive gear 50.

When the arm is extended, the motor 55 operates and the drive gear 50 rotates forward, causing the first connection piece string 21 to be guided by the guide roller 40 to between the upper rollers 31 and the lower rollers 32 in a posture parallel to the center axis of the arm. Along with the movement of the first connection piece string 21, the second connection piece string 22 is guided by a guide rail (not shown) placed behind the ejection section 30, to between the upper rollers 31 and the lower rollers 32 of the ejection section 30. Using the upper rollers 31 and the lower rollers 32, the ejection section 30 presses the first connection piece string 21 and the second connection piece string 22 against each other, thereby forming the columnar body, and supports the columnar body from above, below, left, and right. The columnar body formed by joining together the first connection piece string 21 and the second connection piece string 22 is sent out linearly along the third axis of movement RA3.

When the arm is retracted, the motor 55 operates and the drive gear 50 rotates backward, causing the first connection piece string 21 engaged with the drive gear 50 to be pulled back into the first support body 11a. Along with the movement of the first connection piece string, the columnar body is pulled back into the third support body 11c. The columnar body pulled back is separated at a location behind the ejection section 30. For example, the first connection piece string 21 making up the columnar body is sandwiched between the guide roller 40 and the drive gear 50 while the second connection piece string 22 making up the columnar body is pulled downward by gravity, and consequently, the second connection piece string 22 and the first connection piece string 21 are separated from each other. The separated second connection piece string 22 and first connection piece string 21 are stored in the first support body 11a.

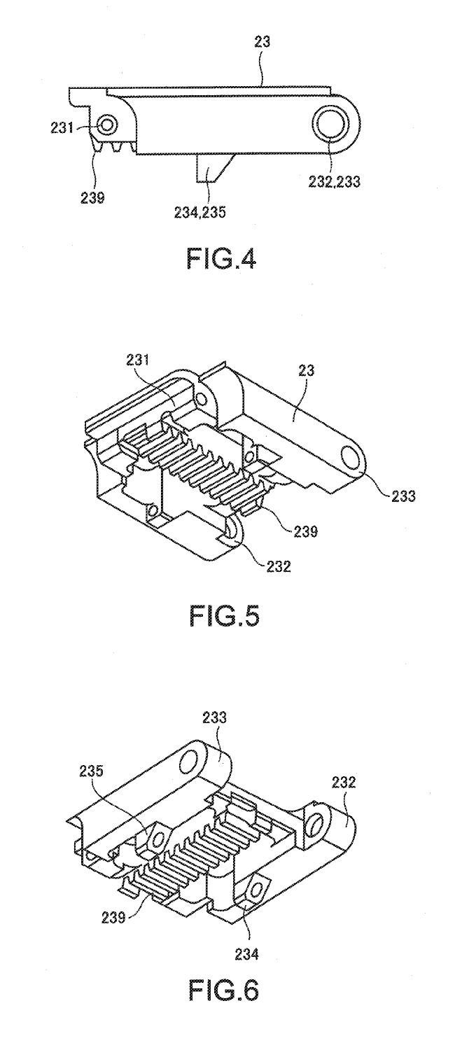

A structure of the arm section 2 of the robot arm mechanism according to the present embodiment is described below with reference to FIGS. 4 to 13. First, a structure of the first connection pieces 23 making up the first connection piece string 21 is described below with reference to FIGS. 4 to 7.

FIG. 4 is a side view showing the structure of the first connection piece 23 of the robot arm mechanism according to the present embodiment. FIG. 5 is a perspective view showing a rear structure of the first connection piece 23 shown in FIG. 4. FIG. 6 is a perspective view showing a front structure of the first connection piece 23 shown in FIG. 4.

Each of the first connection pieces 23 is formed into a substantially flat plate shape. A pinhole case 231 is provided in a center of a rear part of the first connection piece 23. Pinhole cases 232 and 233 are provided on opposite sides in a front part of the first connection piece 23 respectively. A pinhole in each of the pinhole cases 231, 232, and 233 is formed in parallel to a width direction of the first connection piece 23. The pinhole cases 232 and 233 are provided at opposite ends in the width direction, being separated from each other by a distance substantially equivalent to a width of the rear pinhole case 231. The pinhole case 231 in the rear part of the preceding first connection piece 23 is inserted between the front pinhole cases 232 and 233. In this state, the pinholes in the front pinhole cases 232 and 233 and the pinhole in the pinhole case 231 in the rear part of the preceding first connection piece 23 are connected continuously. A single pin is inserted into the pinholes connected continuously. In this way, the plurality of first connection pieces 23 are coupled together in a row, making up the first connection piece string 21. Each pair of successive first connection pieces 23 can rotate relative to each other around the pinholes. This allows the first connection piece string 21 to bend. A bending angle of the first connection piece string 21 can be restricted by a cross sectional shape of the first connection pieces 23, positions of the pinholes, shapes of the pinhole cases 231, 232, and 233, and the like. For example, the first connection piece string 21 may be configured to be bendable inward, but unbendable outward.

Pinhole blocks 234 and 235 each having a trapezoidal cross section are provided, respectively, at centers on opposite sides of an inner surface of the first connection piece 23. A lock pinhole is formed in each of the pinhole blocks 234 and 235.

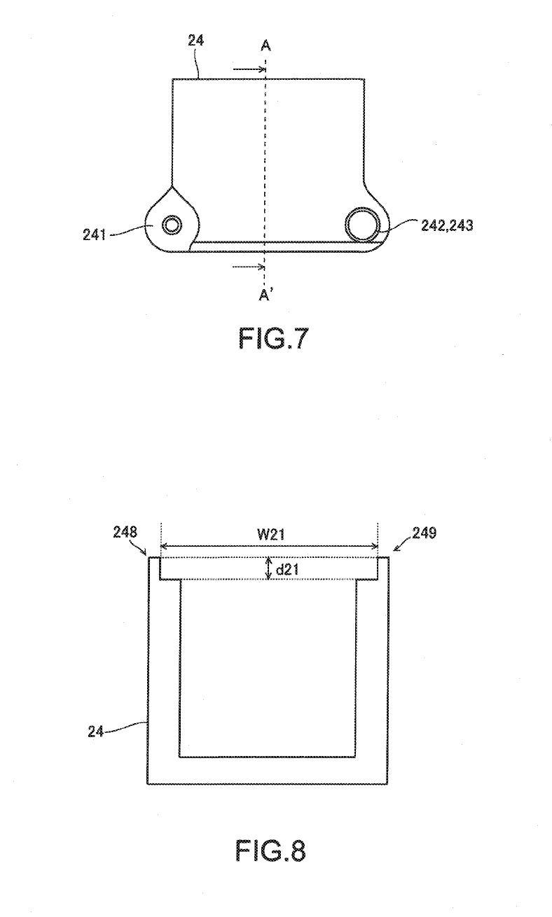

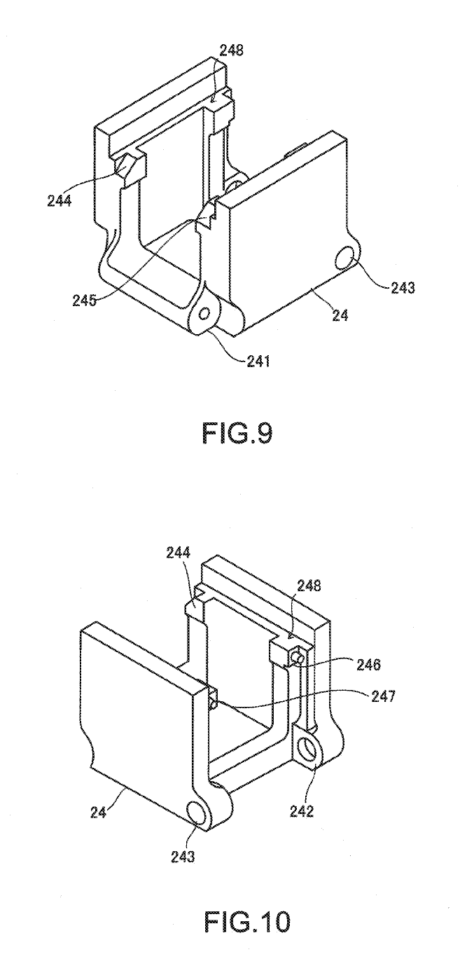

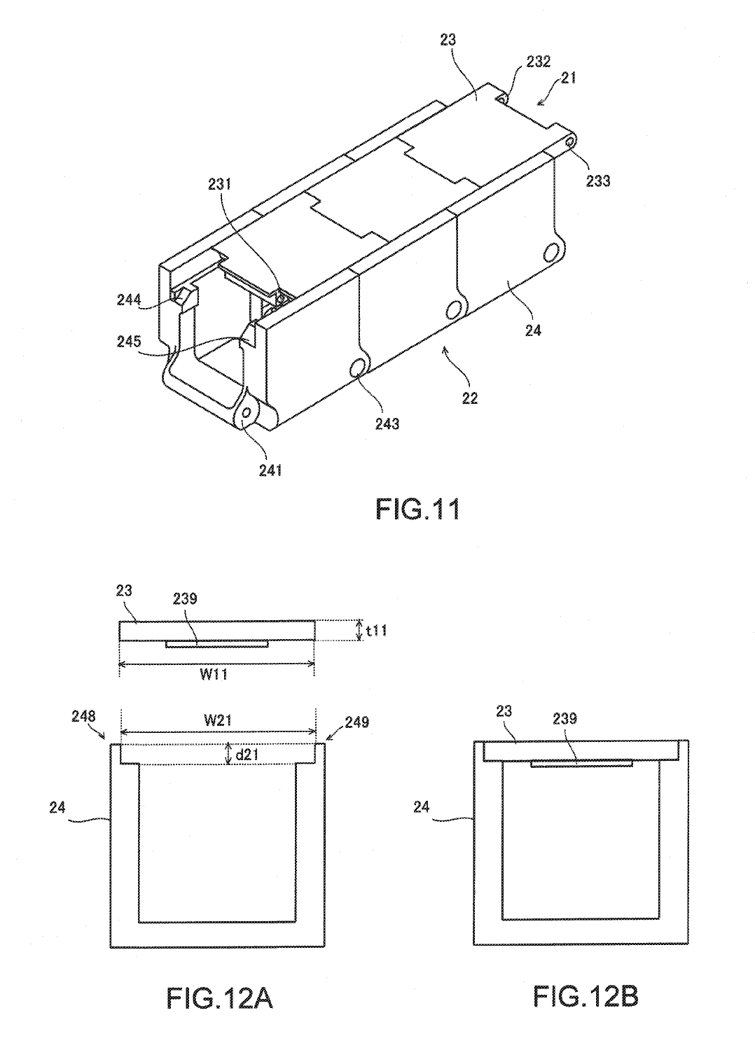

Next, a structure of the second connection pieces 24 making up the second connection piece string 22 is described with reference to FIGS. 7 to 9. Also, a joining structure of the first connection piece string 21 and the second connection piece string 22 is described with reference to FIGS. 10 and 11. FIG. 7 is a side view showing a structure of the second connection piece 24 of the robot arm mechanism according to the present embodiment. FIG. 8 is a sectional view of the second connection piece 24 taken along line A-A′ in FIG. 7. FIG. 9 is a perspective view showing a rear structure of the second connection piece 24 shown in FIG. 7. FIG. 10 is a perspective view showing a front structure of the second connection piece 24 shown in FIG. 7. FIG. 11 is a perspective view showing a structure of the arm section 2 of the robot arm mechanism according to the present embodiment. FIGS. 12A and 12B are sectional views showing a characteristic part of the arm section 2 shown in FIG. 11.

The second connection piece 24 is configured as a short trough-like body. The second connection piece 24 has a substantially U-shaped cross section. Pinhole cases 241, 242, and 243, chuck blocks 244 and 245, and lock pin blocks 246 and 247 are formed integrally with the second connection piece 24.

A pinhole case 241 is provided in a center of a rear part of the second connection piece 24. Pinhole cases 242 and 243 are provided on opposite sides in a front part of the second connection piece 24. A pinhole in each of the pinhole cases 241, 242, and 243 is formed in parallel to a width direction of the second connection piece 24. The pinhole cases 242 and 243 are provided at opposite ends in the width direction, being separated from each other by a distance substantially equivalent to a width of the pinhole case 241 in the rear part. The pinhole case 241 in the rear part of the preceding second connection piece 24 is inserted between the pinhole cases 242 and 243 in the front part. In this state, the pinholes in the pinhole cases 242 and 243 in the front part and the pinhole in the pinhole case 241 in the rear part of the preceding second connection piece 24 are connected continuously. A single pin is inserted into the pinholes connected continuously. In this way, the plurality of second connection pieces 24 are coupled together in a row, making up the second connection piece string 22. Each pair of successive second connection pieces 24 can rotate relative to each other around the pinholes. This allows the second connection piece string 22 to bend inward and outward. A bending angle of the second connection piece string 22 can be restricted by a cross sectional shape, positions of the pinholes, shapes of the pinhole cases 241, 242, and 243, and the like. Since the second connection piece 24 according to the present embodiment has a substantially U-shaped cross section, the second connection piece string 22 has the property of being bendable outward, but unbendable inward.

Chuck blocks 244 and 245 are formed, respectively, in an inner side of upper parts of the opposite side plates at a rear end of the second connection piece 24. Lock pin blocks 246 and 247 are formed, respectively, in an inner side of upper parts of the opposite side plates at a front end of the second connection piece 24. The lock pin blocks 246 and 247 have lock pins which are inserted in the pinholes in the respective pinhole blocks 234 and 235 described above. The lock pins have center axes parallel to a length direction of the second connection piece 24. A shape and shaft length of the lock pins are designed to suit the pinholes. When the second connection piece string 22 is lined up linearly, fitting sockets of a predetermined shape are formed between the chuck blocks 244 and 245 of each second connection piece 24 and the lock pin blocks 246 and 247 of the succeeding second connection piece 24. Shapes and positions of the chuck blocks 244 and 245 and lock pin blocks 246 and 247 are designed such that the fitting sockets will substantially coincide in shape with the pinhole blocks 234 and 235 of the first connection piece 23.

The pinhole blocks 234 and 235 make up a lock mechanism in conjunction with the chuck blocks 244 and 245 and lock pin blocks 246 and 247. The pinhole blocks 234 and 235 are fitted into the respective fitting sockets when the first and second connection piece strings 21 and 22 are lined up linearly, pressing against each other. In so doing, the lock pins on the lock pin blocks 246 and 247 are inserted into the pinholes in the pinhole blocks 234 and 235, respectively. Consequently, the first connection piece 23 is locked to the second connection piece 24. The locked state is maintained as the pinhole blocks 234 and 235 are fitted into the fitting sockets. As shown in FIG. 11, the first and second connection piece strings 21 and 22 joined with each other as described above form a columnar body having a certain degree of rigidity. The columnar body has a tubular shape with a hollow, substantially square cross section.

Description is given below of how the first connection piece string 21 is fitted into the second connection piece string 22 in a structure of the linear extension and retraction mechanism according to the present embodiment. In the present embodiment, the structure in which the first connection piece string 21 is fitted into the second connection piece string 22 is described by taking a stepped fitting structure as an example.

Edge portions 248 and 249 of the opposite side plates of the second connection piece 24 are machined into a stepped shape having two thicknesses. Consequently, a step is formed on each of the edge portions 248 and 249 rising outward from an inner side. For convenience of explanation, surfaces of each of the edge portions 248 and 249 will be divided into an upper-level surface and lower-level surface perpendicular to a side face (surface) of the second connection piece 24, and a stepped surface parallel to the side face of the second connection piece 24. The upper-level surfaces of the edge portions 248 and 249 are also referred to as outer edge surfaces of the side plates of the second connection piece 24. The lower-level surfaces of the edge portions 248 and 249 are also referred to as inner edge surfaces of the side plates of the second connection piece 24. The stepped surfaces of the edge portions 248 and 249 are interposed between the respective upper-level surfaces and lower-level surfaces, and preferably interposed perpendicularly between the upper-level surfaces and lower-level surfaces.

Preferably the upper-level surface and lower-level surface have the same width, i.e., a width ½ the thickness of the side plate. A depth d21 (hereinafter referred to as a level difference d21) of the stepped surface is substantially equivalent to a thickness t11 of the first connection piece 23. Also, a distance W21 between the stepped surfaces of the edge portions 248 and 249 is substantially equivalent to a width W11 of the first connection piece 23. Consequently, as shown in FIG. 11, the first connection piece 23 can be fitted into stepped portions of the opposite side plates of the second connection piece 24. In so doing, an upper opening of the second connection piece 24 is completely lidded by the first connection piece 23. The upper-level surfaces of the edge portions 248 and 249 become continuous with an outer surface of the first connection piece 23. Therefore, the columnar body formed by joining together the first and second connection piece strings 21 and 22 has a hollow square shape almost without irregularities on an outer periphery. The lower-level surfaces of the edge portions 248 and 249 catch the first connection piece 23. The stepped surfaces of the edge portions 248 and 249 hold the first connection piece 23 from sides. In other words, the side plates of the second connection piece 24 are supported from inside by the first connection piece 23.

The above-mentioned stepped fitting structure of the first connection piece string 21 and second connection piece string 22 provides the following advantages. That is, the columnar body is formed by joining together the first and second connection piece strings 21 and 22. In the columnar body, the first connection piece string 21 is fitted into the stepped portions provided on the opposite side plates of the second connection piece string 22, i.e., into the upper opening of the second connection piece string 22. Consequently, side faces of the second connection piece string 22 are supported from inside by the first connection piece string 21. Thus, the linear extension and retraction mechanism according to the present embodiment can improve lateral rigidity of the arm section 2.

Note that the depth d21 of the level difference provided on the opposite side plates of the second connection piece 24 according to the present embodiment is not limited to being substantially equivalent to the thickness t11 of the first connection piece 23.

(First Variation)

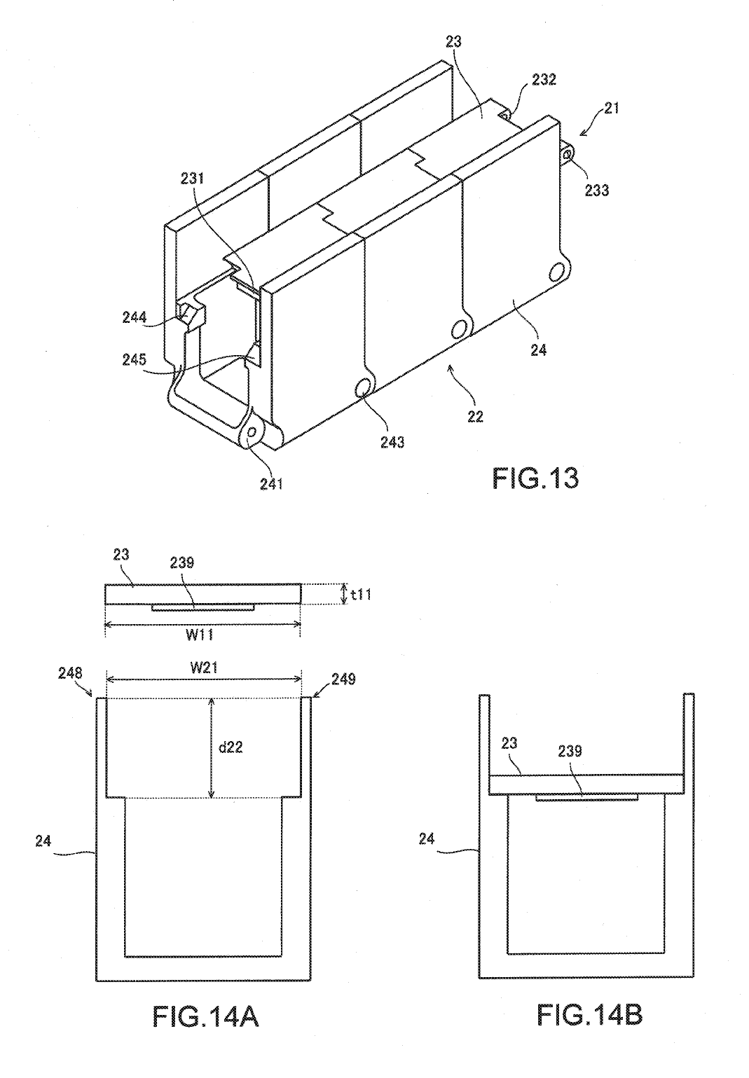

FIG. 13 is a perspective view showing a structure of an arm section 2 of a robot arm mechanism according to a first variation. FIGS. 14A and 14B are sectional views showing a characteristic structure of the arm section 2 of FIG. 13. As shown in FIGS. 14A and 14B, a level difference d22 provided on the edge portions 248 and 249 of the opposite side plates of the second connection piece 24 may be larger than the thickness t11 of the first connection piece 23. As shown in FIG. 13, in the columnar body formed by joining together the first and second connection piece strings 21 and 22, front surfaces of the first connection piece string 21 fitted into the stepped portions of the opposite side plates of the second connection piece string 22 are housed inward of edge surfaces of the opposite side plates of the second connection piece string 22. In other words, the first connection piece string 21 is embedded in the second connection piece string 22. Thus, the first variation can also improve rigidity of the arm section 2.

(Second Variation)

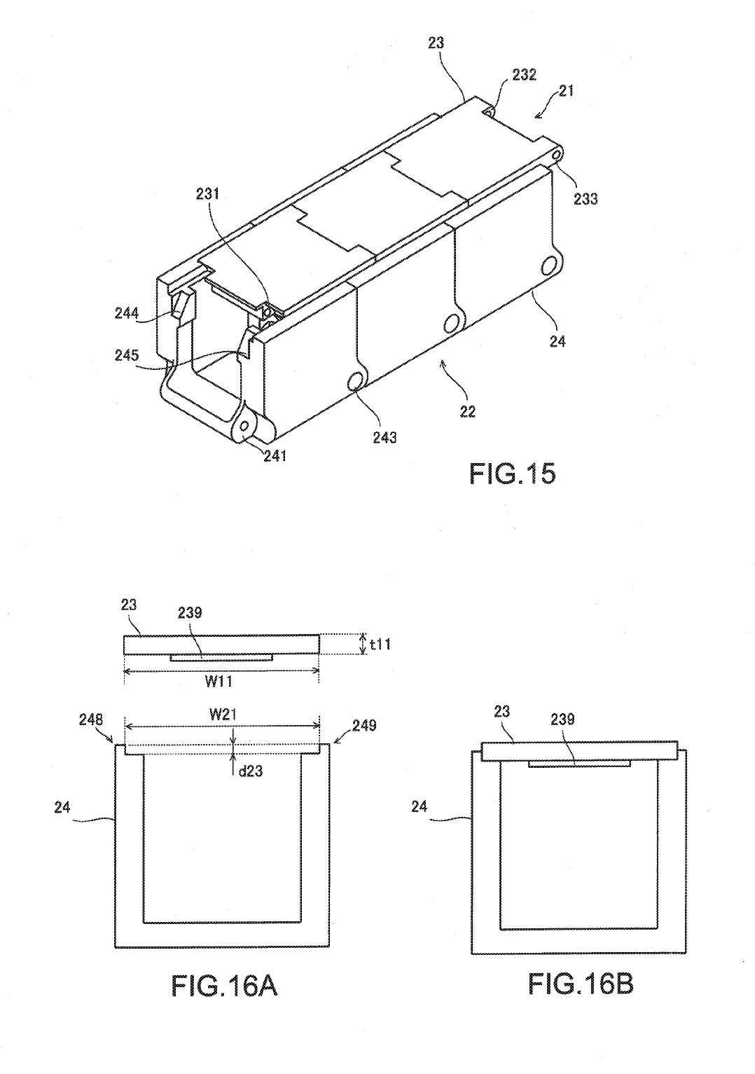

FIG. 15 is a perspective view showing a structure of an arm section 2 of a robot arm mechanism according to a second variation. FIGS. 16A and 16B are sectional views showing a characteristic structure of the arm section 2 of FIG. 15. As shown in FIGS. 16A and 16B, a level difference d23 provided on the edge portions 248 and 249 of the second connection piece 24 may be smaller than the thickness t11 of the first connection piece 23. As shown in FIG. 15, in the columnar body formed by joining together the first and second connection piece strings 21 and 22, the front surfaces of the first connection piece string 21 protrude outward of the edge surfaces of the opposite side plates of the second connection piece string 22. However, the side faces of the second connection piece string 22 are supported from inside by the first connection piece string 21. Thus, the second variation can also improve the rigidity of the arm section 2. Also, the columnar body can be formed into a grooved shape, making a grooved portion available for use.

(Third Variation)

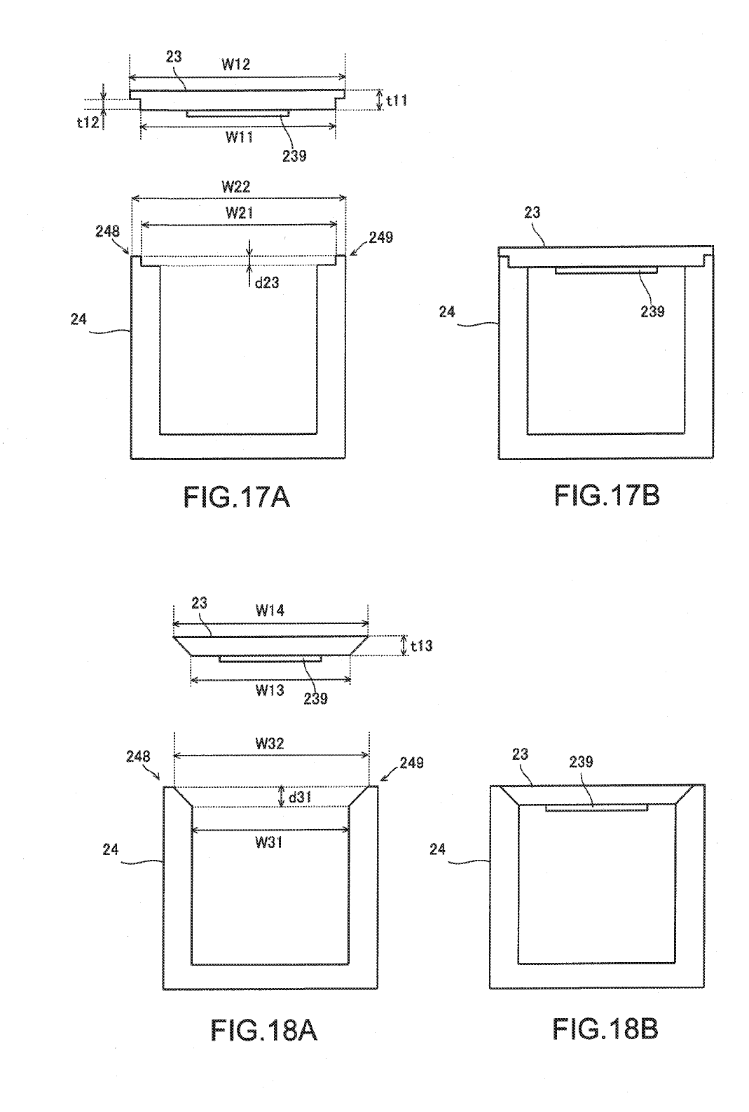

When the level difference d23 provided on the edge portions 248 and 249 of the second connection piece 24 is smaller than the thickness t11 of the first connection piece 23, if the first connection piece 23 is structured as shown in FIGS. 17A and 17B, the rigidity of the arm section 2 can be further improved.

FIGS. 17A and 17B are sectional views showing a characteristic structure of an arm section 2 of a robot arm mechanism according to a third variation. As shown in FIGS. 17A and 17B, the first connection piece 23 has been machined into a stepped shape identical to the stepped shape of the edge portions 248 and 249 of the second connection piece 24. Consequently, a single-step level difference is provided on side faces of the first connection piece 23. The level difference provided on side faces of the first connection piece 23 has a depth t12 substantially equivalent to the level difference d23 provided on the opposite side plates of the second connection piece 24. The outer surface of the first connection piece 23 has a width W12 substantially equivalent to an outer size W22 of the opposite side plates of the second connection piece 24. The inner surface of the first connection piece 23 has a width W11 substantially equivalent to the distance W21 between the stepped surfaces of the edge portions 248 and 249 of the second connection piece 24. The step-shaped edge portions 248 and 249 on the side plates of the second connection piece 24 and step-shaped lateral edge portions of the first connection piece 23 are meshed together. Consequently, the upper opening of the second connection piece 24 is covered completely with the first connection piece 23. The columnar body formed by joining together the first and second connection piece strings 21 and 22 has a hollow square cross section almost without irregularities on an outer periphery. Thus, a fitting structure shown in FIGS. 17A and 17B can improve the rigidity of the arm section 2 more greatly than can a fitting structure shown in FIGS. 15, 16A and 16B.

(Fourth Variation)

A structure in which the first connection pieces 23 are fitted into the second connection pieces 24 has been described so far by taking a stepped fitting structure as an example. However, another structure may be used as long as the first connection pieces 23 are fitted into the second connection pieces 24. For example, a tapered fitting structure may be used to fit the first connection piece string 21 into the second connection piece string 22.

FIGS. 18A and 18B are sectional views showing a characteristic structure of an arm section 2 of a robot arm mechanism according to a fourth variation. As shown in FIGS. 18A and 18B, the first connection piece 23 has an isosceles trapezoidal cross section. Opposite side faces of the first connection piece 23 are sloped, spreading outward from an inner side. A taper which narrows inward from an outer side is provided. The outer surface of the first connection piece 23 has a width W14 larger than a width W13 of the inner surface of the first connection piece 23.

The edge portions 248 and 249 of the opposite side plates of the second connection piece 24 are machined into a tapered shape with a spreading opening. Specifically, the edge portions 248 and 249 of the opposite side plates of the second connection piece 24 are sloped, spreading outward from an inner side. That is, the edge portions 248 and 249 are sloped such that the side plates will be reduced in thickness toward the edge surfaces. The tapered portions of the opposite side plates have a depth d31 not smaller than, and preferably, substantially equivalent to, a thickness t13 of the first connection piece 23. The tapered portions of the opposite side plates have an inside width W31 substantially equivalent to the width W13 of the inner surface of the first connection piece 23. The tapered portions of the opposite side plates have an outside width W32 substantially equivalent to the width W14 of the outer surface of the first connection piece 23. Consequently, as shown in FIGS. 18A and 18B, the opposite side faces of the first connection piece 23 fit in the tapered portions on the opposite side plates of the second connection piece 24. Therefore, the columnar body formed by joining together the first and second connection piece strings 21 and 22 has a hollow square cross section almost without irregularities on the outer periphery. The slopes formed on the edge portions 248 and 249 catch the first connection piece 23 and hold the first connection piece 23 from outside. In other words, the side plates of the second connection piece 24 are supported from inside by the first connection piece 23. Thus, the fourth variation can also improve the rigidity of the arm section 2, and moreover, can join and separate the first connection pieces 23 to and from the second connection piece 24 smoothly.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A linear extension and retraction mechanism comprising:
a first connection piece string, the first connection piece string including a plurality of first connection pieces coupled together bendably, the plurality of first connection pieces being shaped like a flat plate;
a second connection piece string, the second connection piece string including a plurality of second connection pieces coupled together bendably, the plurality of second connection pieces being provided with a U-shaped cross section, a foremost one of the plurality of second connection pieces being connected with a foremost one of the plurality of first connection pieces, the first and second connection piece strings being joined with each other to constrain bending, thereby a columnar body having a tubular shape being formed, the columnar body being relaxed when the first and second connection piece strings are separated from each other; and
an ejection section adapted to join the first connection piece string to the second connection piece string and support the columnar body, wherein
the first connection pieces have a width substantially equivalent to spacing between side plates of the second connection pieces and are fitted into the second connection pieces.

2. The linear extension and retraction mechanism according to claim 1, wherein a level difference is formed on inner edges of the side plates of the second connection pieces, and the first connection pieces are fitted into the level difference.

3. The linear extension and retraction mechanism according to claim 2, wherein the level difference has a depth substantially equivalent to a thickness of the first connection pieces.

4. The linear extension and retraction mechanism according to claim 2, wherein the level difference is larger than a thickness of the first connection pieces.

5. The linear extension and retraction mechanism according to claim 2, wherein the level difference is smaller than a thickness of the first connection pieces.

6. A linear extension and retraction mechanism comprising:
a first connection piece string, the first connection piece string including a plurality of first connection pieces coupled together bendably, the plurality of first connection pieces being shaped like a flat plate;
a second connection piece string, the second connection piece string including a plurality of second connection pieces coupled together bendably, the plurality of second connection pieces being provided with a U-shaped cross section, a foremost one of the plurality of second connection pieces being connected with a foremost one of the plurality of first connection pieces, the first and second connection piece strings being joined with each other to constrain bending, thereby a columnar body having a tubular shape being formed, the columnar body being relaxed when the first and second connection piece strings are separated from each other; and
an ejection section adapted to join the first connection piece string to the second connection piece string and support the columnar body, wherein
the first connection pieces have an isosceles trapezoidal cross section, and edge portions of opposite side plates of the second connection pieces are sloped, spreading outward from an inner side, in accordance with a cross sectional shape of the first connection pieces.

7. The linear extension and retraction mechanism according to claim 6, wherein the slope has a height substantially equivalent to a thickness of the first connection pieces.

8. A robot arm mechanism equipped with a linear extension and retraction mechanism, the linear extension and retraction mechanism comprising:
a first connection piece string, the first connection piece string including a plurality of first connection pieces coupled together bendably, the plurality of first connection pieces being shaped like a flat plate;
a second connection piece string, the second connection piece string including a plurality of second connection pieces coupled together bendably, the plurality of second connection pieces being provided with a U-shaped cross section, a foremost one of the plurality of second connection pieces being connected with a foremost one of the plurality of first connection pieces, the first and second connection piece strings being joined with each other to constrain bending, thereby a columnar body having a tubular shape being formed, the columnar body being relaxed when the first and second connection piece strings are separated from each other; and
an ejection section adapted to join the first connection piece string to the second connection piece string and support the columnar body, wherein
the first connection pieces have a width substantially equivalent to spacing between side plates of the second connection pieces and are fitted into the second connection pieces.
